(19) United States
(12) Patent Application Publication
(10) Pub. No.: US 2010/0269352 A1
(43) Pub. Date: Oct. 28, 2010

(54) Y PEELER

(75) Inventor: Heather Curtin, Duarte, CA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/753,752

(22) Filed: Apr. 2, 2010

Related U.S. Application Data
(60) Provisional application No. 61/173,530, filed on Apr. 28, 2009.

(51) Int. Cl. A47J 17/02; B26B 5/00

(52) U.S. Cl. 30/123.5; 30/337; 30/125; 99/588

(57) ABSTRACT

A preferred vegetable peeler includes a handle and a tool head, with the tool head being configured to removably hold a blade. The blade may be formed in any of a variety of ways, including a standard straight peeling blade, a serrated or scalloped blade, or other configurations. The tool head or blade holder in accordance with the present invention includes two branches extending away from a proximal end of the handle in order to hold the blade at an angle that is preferably substantially perpendicular to the handle. A cavity in the handle is configured to store one or more replacement blades.

### PRIORITY CLAIM

This application claims the benefit of U.S. Provisional Application Ser. No. 61/173,530 filed Apr. 28, 2009; contents of which are incorporated herein.

### FIELD OF THE INVENTION

This invention relates generally to kitchen tools for peeling fruits and vegetables.

### BACKGROUND OF THE INVENTION

Peeling devices are commonly used for peeling fruits and vegetables such as apples, carrots, or potatoes. Some such peeling devices are in the shape of a Y in which the blade is generally perpendicular to the handle. The blades for such devices are most often in the form of an elongated member having an internal opening with sharpened edges, in which the skin of the item to be peeled is cut by one of the sharpened opening edges, allowing the peel to pass through the internal opening. The sharpened blade edges may be straight, serrated, scalloped, or otherwise formed in order to produce a desired peel trimming or a desired effect on the fruit or vegetable meat after the peel is removed.

In order to use a different type of blade, however, a different peeler must be used. Current vegetable peelers do not allow for the possibility of replacing old dull blades or exchanging a serrated or scalloped blade for a straight blade.

### SUMMARY OF THE INVENTION

A preferred vegetable peeler includes a handle and a tool head, with the tool head being configured to removably hold a blade. The blade may be formed in any of a variety of ways, including a standard straight peeling blade, a serrated or scalloped blade, or other configurations. The tool head or blade holder in accordance with the present invention includes two branches extending away from a proximal end of the handle in order to hold the blade at an angle that is preferably substantially perpendicular to the handle.

Although ideally suited for peeling vegetables, it should be understood that within this specification the term “vegetable” is intended to encompass fruits and other food items that can be peeled with such a device.

In some preferred versions the mechanism for holding the blade includes a central blade-retaining collar that interacts with the blade mount configured to hold the blade. The collar is rotatable allows the blade to be either secured to or removed from the tool head.

The handle is preferably cylindrical in cross-sectional shape, and forms an internal cavity that is sized and configured to be able to receive and store at least one spare cutting blade.

In other versions the handle is formed in a square, polygonal, or other cross-sectional shape that is configured to receive and retain replacement blades.

### BRIEF DESCRIPTION OF THE DRAWINGS

Preferred and alternative examples of the present invention are described in detail below with reference to the following drawings:

FIG. 1 is a front view of a preferred vegetable peeler in accordance with the invention.

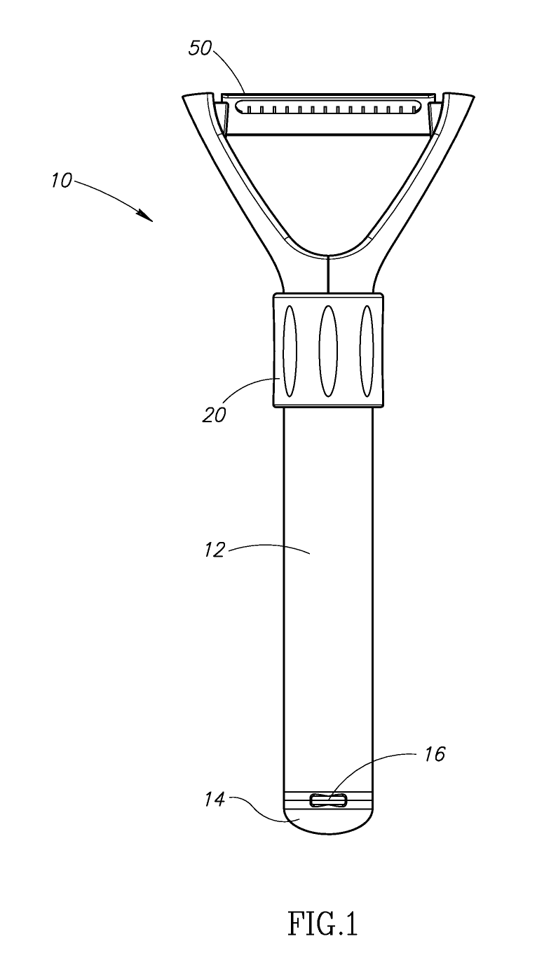

FIG. 2 is a top perspective view of a preferred vegetable peeler in accordance with the invention.

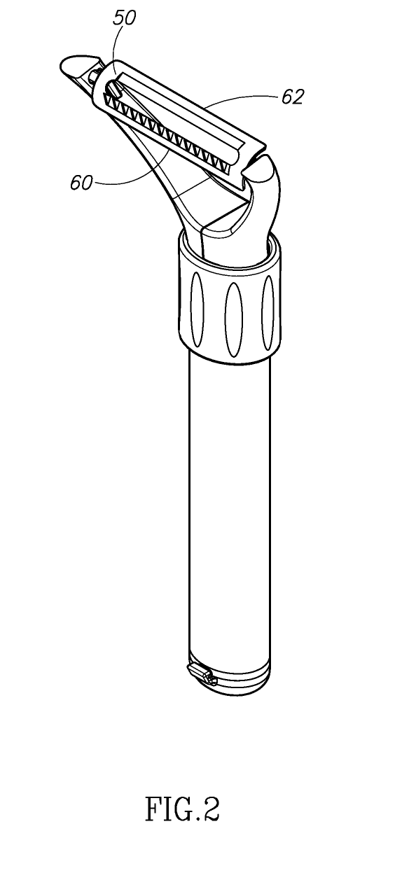

FIG. 3 is a front partially exploded view of a preferred vegetable peeler in accordance with the invention.

FIG. 4 is a top perspective exploded view of a preferred vegetable peeler in accordance with the invention.

### DETAILED DESCRIPTION OF THE PREFERRED EMBODIMENT

A preferred version of the vegetable peeler 10 is shown in the figures. The peeler 10 includes an elongated handle 12 which, in the version as shown, is generally cylindrical in shape. The handle has a proximal end and a distal end, with sidewalls that form an internal cavity that is sized and configured to be able to receive and store at least one spare cutting blade, as discussed further below. The handle need not be cylindrical, and in other versions the handle is formed in a square, polygonal, or other cross-sectional shape.

The handle 12 terminates in an end cap 14 at the distal end of the peeler handle, with the end cap providing a removable closure to retain a spare blade within the handle. In the illustrated example of the invention, the end cap 14 is permanently secured to the handle 12 via a living hinge 16, such that the handle and end cap are integrally formed from plastic to ensure that the end cap is always attached to the handle. In this fashion, the end cap can pivot to an open position via the living hinge to allow access to the internal cavity and spare blade then can pivot to a closed position in which it seals the cavity to retain the spare blade. As shown, the end cap includes either a snap fit or a frictional fit to secure the end cap to the handle in a closed position.

In other versions of the invention, the living hinge may be omitted. In such versions, the end cap may secure to the handle in a friction-fit or snap-fit arrangement as discussed above. Alternatively, the end cap may fasten to the handle in a threaded arrangement or in any other manner capable of generally enclosing the cavity to retain the spare blade. Though plastic is used in the preferred version as discussed above, metal or other materials may be used in other versions of the invention.

The proximal end of the handle (opposite the distal end with the end cap) terminates in a pair of arms 30, 32 that are configured to hold the blade 50 in place. In the illustrated example of the invention the arms fold a blade holder that, together with the handle, generally forms the shape of a Y.

The arms 30, 32 diverge from the handle in directions that are opposite one another and include a channel or gap 34 that is provided at the location substantially at the juncture where the arms join to the handle. The gap is generally co-axial with the handle and provides a degree of separation at the base of the arms where the arms join the handle. The tool is formed such that the natural position of the arms will produce the gap 34. In other words, when the handle and arms are integrally formed from a plastic material, the gap is formed at the junction of the arms in such a way that a force is required to close the gap. At the same time, the size of the gap and the rigidity and choices of materials is such that when a force is applied to opposing sides of the base of the arms, the gap is closed and the working ends of the arms are urged toward one another. When the gap-closing force is removed, the natural formation of the handle and arms will urge the gap open again, and likewise urge the working end of the arms to slightly separate from one another.

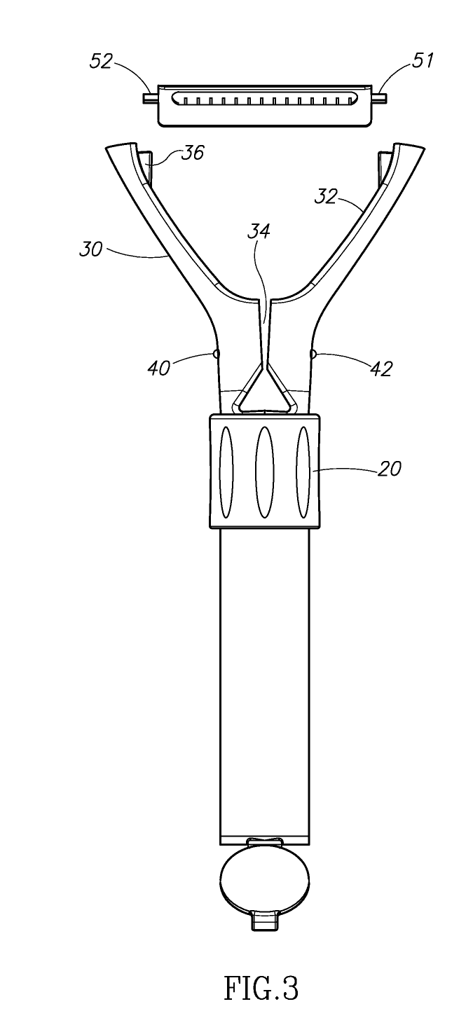

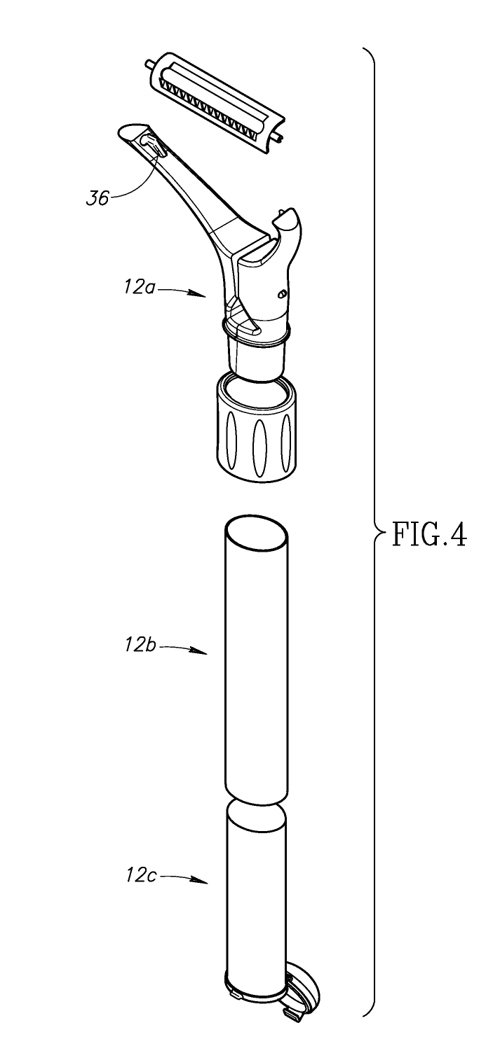

As best seen in FIGS. 3 and 4, the gap may widen into a larger opening toward the base of the gap. As illustrated, this opening is generally triangle shaped and provides a thinner and therefore somewhat weakened zone generally at the juncture where the arms join the handle. This weakened zone allows the arms to more readily separate to remove the blade, as discussed further below.

The working ends of each of the arms terminates in a seat 36, with each of the seats on the respective arms facing inward, toward the opposite arm. The seats 36 are integrally formed with the arms and are generally in the form of a peripheral flange creating a central recessed region or cavity at the interior surface of the distal ends of the arms. The cavities formed as the seats are preferably oriented to face one another and configured to support the blade, as described below.

The blade 50 terminates on each side with a pin 51, 52 that is sized and shaped to be received within the cavities formed by the seats. When each of the opposing pins 51, 52 is received within a respective seat, the blade is then pivotally mounted within the channels formed in the seats and therefore the arms of the tool.

The pins may be permanently affixed to the blades and pivot with respect to the seats, thereby allowing the blade to be pivotally mounted to the blade holder. Alternatively, the pins may be pivotally carried on the blade to provide pivotal movement of the pins with respect to the blades. In such a configuration, the pins may be frictionally held within the collars in a manner that allows little or no rotational movement, with the pivotal movement of the blade being provided at the connection of the pins to the blade. In yet other configurations, the pin may be integrally formed with the blade and retained with the collar without allowing for pivotal movement. Likewise, though a minimal amount of pivotal movement of the blade with respect to the arms is preferred, in other versions of the invention the blade is more rigidly secured to the arms. In such versions, a connection means other than a pin and collar may be used.

The arms and gap formed at the base of the arms are configured such that the width between the opposing seats is somewhat greater than the width between the opposing pins of the blade. In this relaxed position, the blade will readily fall out of the seats unless some urging force closes the gap and therefore urges the arms toward one another. In the preferred embodiment, a collar or sleeve 20 is slideably movable between the distal end of the handle and the juncture of the handle and the arms. In a downward position, with the sleeve located relatively toward the distal end, the sleeve provides no force on the portion of the handle that includes the gap, and the arms are therefore naturally separated from one another. When the sleeve is moved to an upward position, substantially covering the gap or at least in a position in which it surrounds a portion of the gap, the sleeve produces a force against a portion of the handle that includes the gap, thereby urging the gap to close and the arms to be pushed toward one another. In order to accomplish this urging function, the internal diameter of the sleeve is preferably less than an external diameter of the portion of the handle that includes the gap in its natural resting position.

One or more bumps or knobs 40, 42 is provided on an outer surface of the handle in the vicinity of the juncture of the handle and the arms. The knobs are configured to engage a mating rib, shoulder, or other corresponding surface on the interior of the sleeve 20 in order to hold the sleeve in an upward position, surrounding the gap.

In other versions of the invention, the sleeve may be frictionally fit, threadably secured, or yet other structures may be incorporated to hold the sleeve in its position that urges the gap to be closed.

In this upper position, the sleeve urges the arms toward one another, and thereby allows the seats to retain the blade in place in which the blade 50 is pivotally and securely retained within the arms.

The handle may be formed as a single integral unit, or may alternatively be formed in multiple sections that are joined together. As shown in the exploded view of FIG. 4, in one version of the invention the device is formed in three main pieces, including an upper portion 12a forming the arms, a central portion 12b providing a mount to the arms and including the proximal portion of the handle, and a lower portion 12c that includes the internal cavity for storing additional blades and defines the distal portion of the handle. The sections are then joined together using glue, sonic welds, friction fittings, threaded fasteners, or other means.

When the collar 20 is slid downward, toward the distal end of the handle, the gap naturally opens and the arms spread apart somewhat. This allows the blade to be readily removed from the arms. If desired, the blade can be removed and replaced with a different blade configuration. As described above, one or more additional blades may be stored within the handle, accessible by removing the end cap. One of the stored blades may then be removed from the handle, positioned within the seats, and then the sleeve moved back in place to urge the gap closed so that the tool may be used again. The extra blade is then placed in the cavity within the handle and the end cap closed for storage.

One blade as shown in the figures may be used for making julienne strips. Thus, the blade 50 may include a first edge 60 having a sharpened peeling edge and a number of orthogonal slicing blades that cut the peelings into strips. An opposing edge 62 may include only a straight peeling edge. An alternative blade may include a pair of opposing straight peeling edges, one or more serrated edges, a scalloped edge, or other blade configurations.

With the preferred peeler as described above, a single tool can be used in several different peeling configurations. An ordinary peeling blade may be used for one task, and the ordinary peeling blade later may be exchanged for a serrated blade, a julienne blade, a scalloped blade, or any other blade configuration as desired. The size of the handle may be such that one or several substitute blades may be stored within the internal cavity, allowing for quick and convenient modification of the tool as desired.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A device for separating the peel from fruits or vegetables, comprising:
a handle having a distal end and a proximal end, the handle having an exterior surface and an interior surface defining an internal cavity;
a blade mount adjacent the proximal end of the handle, the blade mount having a first arm extending from the proximal end of the handle and having a distal end, and a second arm extending from the proximal end of the handle and having a distal end, the first arm and the second arm diverging from one another as they extend away from the proximal end of the handle, a gap being defined at a juncture where the first arm and the second arm extend away from the proximal end of the handle;
a first seat formed in the first arm and a second seat formed in the second arm;
a first blade having a first end and a second end, the blade being removably secured to the blade mount with the first end of the blade received in the first seat and the second end of the blade received in the second seat; and
a collar carried on the handle and selectively positionable in a first position in which the gap is opened and a second position in which the arms are urged toward one another by the collar and the gap is relatively more closed than in the first position;
wherein when the collar is in the first position the first blade is removable from the blade mount and when the collar is in the second position the first blade is retained within the blade mount.

2. The device of claim 1, further comprising a first pin extending from the first end of the first blade, and a second pin extending from the second end of the first blade, the first pin being received in the first seat and the second pin being received in the second seat.

3. The device of claim 2, wherein the first seat comprises a first cavity formed in the distal end of the first arm and the second seat comprises a second cavity formed in the distal end of the second arm.

4. The device of claim 3, wherein the collar is slideably movable along the external surface of the handle.

5. The device of claim 4, further comprising a knob formed on an external surface of the device substantially at the juncture where the first arm and the second arm extend away from the proximal end of the handle, and a shoulder formed on the collar, the shoulder being positioned to engage the knob to hold the collar in the second position.

6. The device of claim 3, further comprising an end cap for enclosing the internal cavity of the handle.

7. The device of claim 3 wherein the end cap is secured to the handle via a living hinge.

8. The device of claim 3, further comprising a second blade retained within the internal cavity.

9. A device for separating the peel from fruits or vegetables, comprising:
a handle having a distal end and a proximal end defining a longitudinal handle axis generally from the distal end to the proximal end, the handle having an exterior surface and an interior surface defining an internal cavity;
a blade mount extending from the handle, the blade mount having a first arm and a second arm, the first arm and the second arm diverging from one another as they extend away from the proximal end of the handle; and
a first blade having a first end and a second end, the first blade being removably secured to the blade mount with the first end of the first blade being secured to the first arm and the second end of the first blade being secured to the second arm, the first blade when secured to the blade mount extending from the first arm to the second arm in a direction that is generally perpendicular to the handle axis;
at least one of the first arm and the second arm being movable apart from the other such that first blade is removable from the blade mount when first arm or the second arm is moved apart from the other.

10. The device of claim 9, further comprising an end cap removably attached to the handle for enclosing the internal cavity of the handle.

11. The device of claim 10 wherein the end cap is attached to the handle via a living hinge.

12. The device of claim 10, further comprising a second blade retained within the internal cavity.

13. The device of claim 9, further comprising a first pin extending from the first end of the first blade, and a second pin extending from the second end of the first blade, the first pin being received by the first arm and the second pin being received by the second arm.

14. The device of claim 13, further comprising a first seat formed in the first arm and a second seat formed in the second arm, the first seat comprising a first cavity formed in the distal end of the first arm and the second seat comprising a second cavity formed in the distal end of the second arm, the first pin being received in the first seat and the second pin being received in the second seat.

15. The device of claim 10, further comprising a collar carried on the handle and movable longitudinally along the handle between a first position in which the first arm and the second arm are movable apart from another and a second position in which the first arm and the second arm are urged toward one another by the collar.

16. The device of claim 15, further comprising at least one knob formed on an external surface of the handle, and a shoulder formed on the collar, the shoulder being positioned to engage the knob to hold the collar in the second position.
